(19) United States
(12) Patent Application Publication
(10) Pub. No.: US 2004/0098385 A1
(43) Pub. Date: May 20, 2004

(54) Method for indentifying term importance to sample text using reference text

(76) Inventors: James C. Mayfield, Silver Spring, MD (US); J. Paul McNamee, Ellicott City, MD (US)

Correspondence Address: Benjamin Y Roca Office of Patent Counsel, The Johns Hopkins University, Applied Physics Laboratory, 11100 Johns Hopkins Road, Laurel, MD, 20723-6099, US

(21) Appl. No.: 10/469,445

(22) PCT Filed: Feb. 26, 2002
(86) PCT No.: PCT/US02/06036

(51) Int. Cl. G06F 17/30

(52) U.S. Cl. 707/3

(57) ABSTRACT

A method and apparatus for identifying important terms in a sample text. A frequency of occurrence of terms in (sample frequency) is compared to a frequency of occurrence of those terms in a reference text (reference frequency). Terms occurring with higher frequency in the sample text than in the reference text are considered important to the sample text. A difference between the respective sample and reference frequencies of a term may be used to determine an importance score. Terms can be ranked and/or added to an affinity set as a function of importance score or rank. When there are insufficient terms for determining a sample frequency, those terms may be used in a search query to identify documents for use as sample text to determine sample frequencies. The important terms may be used for document summarization, query refinement, cross-language translation, and cross-language query expansion.

### CROSS-REFERENCE TO RELATED APPLICATIONS

This application claims the benefit of prior filed co-pending U.S. application Ser. Nos. 60/271,962 and 60/271,960, both filed Feb. 28, 2001, the disclosures of which are hereby incorporated herein by reference.

### BACKGROUND OF THE INVENTION

1. Field of the Invention

The present invention relates generally to computerized systems for searching and retrieving information. In particular, the present invention relates to textual analysis and identification of terms that are important to a body of text.

2. Description of the Related Art

It is often difficult to determine the gist of a body of text, such as a document or group of documents, when the body of text is not considered in its entirety. This can cause problems for computerized text-based information retrieval systems. Such systems are now in widespread use for database, intranet and internet-based (e.g. World Wide Web) applications. In many such systems, search terms, such as words, stemmed words, n-grams, phrases, etc., are provided by a user to information retrieval software. The information retrieval software, e.g. a Web search engine, uses such search terms in a well-known manner to search a group of documents and identify documents relevant to the search query.

A common problem for information retrieval systems is the manner by which documents (e.g., a phrase, sentence, paragraph, file, group of documents or what is more traditionally a ‘document’ are considered to be important, or relevant, to the user's search, as is the determination as to relative relevance of documents retrieved. This problem is particularly acute in the Web context because the group of documents searched is particularly large and heterogeneous. Accordingly, the number of retrieved documents is typically very large, and often larger than a user can carefully consider. Many search engines provide for relevance-based rankings of search results so that the most relevant results (as determined by the search engine) are displayed to the user first.

Careful preparation of a search query can improve the relevance of the search results. Typically, however, a user does not construct the best possible search query. If the search query is too broad, the search results are likely to include so many documents that the user may never actually review documents important to the user because of the length of the list of search results. Alternatively, if the search query is too narrow, the list of search results may exclude documents that may have been important to the user.

Accordingly, it is desirable to identify terms closely related to a search term that may be used to refine a search query. Additionally, it is desirable to identify terms of a document that are most relevant to the gist of the document. For example, such terms could be used to facilitate identification of relevant search results when performing text-based retrieval, to quickly convey the gist of the document in a list-type abstract form, to highlight important terms to allow for a quick reading of the most relevant parts of a document, to provide for automated generation of document summaries, to assist in cross-language translations, etc.

### SUMMARY OF THE INVENTION

The present invention provides a method and apparatus for identifying terms, e.g., words, groups of words, or parts of words, that are important to a given text (sample text) by comparing the frequency of occurrence of terms in the sample text to a benchmark frequency, e.g. a frequency of those terms in a reference text, e.g. any large text sample.

An exemplary method for identifying important terms of a sample text includes the step of determining a frequency of occurrence within the sample text (“sample frequency”) for each of a plurality of terms of the sample text. The method also includes the step of comparing a term's sample frequency to its respective frequency of occurrence within a reference text, such as a large text sample (“reference frequency”). The reference frequency provides a benchmark for determining relative importance to the sample text. Terms that occur with greater frequency in the sample text than in the reference text are deemed to be relatively important to the sample text.

A difference between the respective frequencies of a term may be used to determine an importance score. For example, the arithmetic difference of the respective frequencies may be used as an importance score. Alternatively, a function or a weighting technique, such as an inverse document frequency function may be incorporated into an importance score that reflects the different frequencies. In this manner, terms of the sample text may be compared by importance score to determine relative importance to the sample text.

According to the present invention, a subset of all important terms including the most important terms may be taken as the important terms. That subset is referred to herein as the “affinity set”. A cutoff for determining which terms to include in an affinity set may be established in any suitable fashion. For example, a threshold importance score may be established such that all important terms having an importance score exceeding the threshold are included in the affinity set. Alternatively, the important terms of the sample text may be sorted/ranked in order of decreasing importance or importance scores and the affinity set may include a top X% or the top Y terms.

The affinity set has many applications. For example, when it is desired to find related terms, e.g. to refine a search query, a group of search results identified by a corresponding search query may be used as a sample text. An affinity set of the sample text may then be created to identify terms important to the sample text. Because the sample text is related to the search query (one or more terms), the important terms are considered to be related to the search query and therefore may be suitable for query refinement. The refined search query will likely lead to more relevant search results. By way of further example, an affinity set of terms for a document may be presented (e.g. displayed on a computer monitor) as an abstract of the document from which the affinity set was created. Alternatively, a document may be displayed, e.g. on a computer monitor, highlighting terms from the affinity set for the document, or the affinity set for a query used to retrieve the document, to allow a reader to quickly scan the document for its gist. The affinity set may also be used for cross-language translation and/or cross-language query expansion, as discussed in detail below.

### BRIEF DESCRIPTION OF THE DRAWINGS

FIG. 1 is a flow diagram illustrating an exemplary method for identifying reference frequencies using reference text, as known in the prior art;

FIG. 2 is a flow diagram illustrating an exemplary method for identifying term importance to a sample text according to the present invention;

FIG. 3 is a flow diagram illustrating an exemplary method for creating an affinity set including important terms according to the present invention;

FIG. 4 is a flow diagram illustrating an exemplary method for using the affinity set for summarization according to the present invention;

FIG. 5 is a flow diagram illustrating an exemplary method for using the affinity set for query refinement according to the present invention;

FIG. 6 is a flow diagram illustrating an exemplary method for using important terms for cross-language translation according to the present invention;

FIG. 7 is a flow diagram illustrating an exemplary method for using important terms for cross-language query expansion according to the present invention; and

FIG. 8 is a block diagram of an information retrieval system in accordance with the present invention.

### DETAILED DESCRIPTION

Conceptually, the present invention is directed toward identifying terms that are important to a sample text by comparing each term's frequency in the sample text to its frequency in a reference text. Terms that occur with greater frequency in the sample text than in the reference text are deemed to be relatively important to the sample text. The magnitude of differences in respective frequencies are used to determine their relative importance to the sample text.

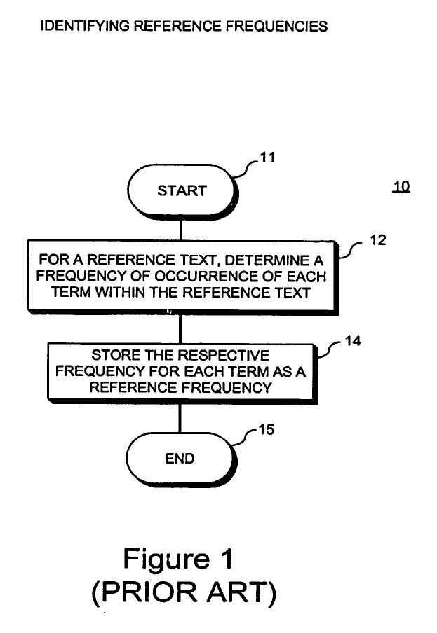

FIG. 1 is a flow diagram 10 illustrating an exemplary technique for identifying term frequencies in reference text. Numerous indexing techniques are well known in the art for identifying term frequencies. The reference text may be a large document, or preferably, a very large collection of documents. The collection may be topic-specific, author-specific, publisher specific, etc. The large text sample may be selected by a user or an information retrieval system, arbitrarily or otherwise. For example, a text-based, electronic database of news articles or articles excerpted from an encyclopedia may be used as reference text. According to the present invention, these frequencies are used as reference frequencies for comparison purposes.

As shown in steps 11 and 12 of FIG. 1, the method for identifying reference frequencies may start with determining a frequency of occurrence of each term within the reference text. A “frequency” as used herein refers to a measure of how common a term is with respect to a body of text. The frequency may be determined in any suitable way and using any suitable metric. Numerous techniques and software for determining frequencies are well-known in the art.

A frequency of a term may be expressed in various ways. For example, a frequency may be expressed in terms of occurrences per document, occurrences per group of documents, or as a fraction of total documents in a group of documents that include the given term (or have another property), etc.

The frequency of terms in reference text will be later used as the reference frequency. Therefore, as shown in FIG. 1, the respective frequency for each term is stored as a reference frequency, as shown at step 14. For example, the terms and the corresponding reference frequencies may be stored as part of an index in a memory of a computerized information retrieval system, as is well known in the art. Accordingly, reference frequencies need not be determined every time a search is performed. Rather, reference frequencies may be determined in advance of a search (or infrequently), and may be accessed quickly, e.g. by consulting an index. Alternatively, reference frequencies may be determined by a third party and stored in a database imported or accessed by an information retrieval (or information processing) system only as necessary.

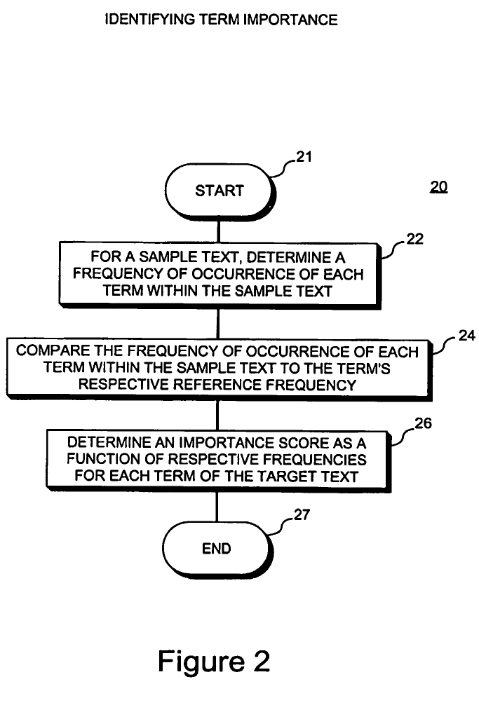

FIG. 2 is a flow diagram 20 illustrating an exemplary method for identifying term importance to a sample text according to the present invention. For example, the sample text could be a phrase, paragraph, document, group of documents, etc. The body of sample text may be defined in various ways. For example, it may be specified by a user, e.g. all books or articles written by a certain author, all transcripts of speeches of a certain politician, all documents identified by executing a designated search query, etc. Any suitable method may be used for identifying a sample text. However, it is often useful to select sample text having a common property so that the important terms, when identified, are more likely to be associated with, or indicative of, that property.

As shown in the flow diagram 20 of FIG. 2, the exemplary method for identifying term importance starts with determining a frequency of occurrence of each term (or each desired term) within the sample text, as shown at steps 21 and 22. That frequency is referred to herein as the “sample frequency”. The sample frequency is determined for multiple terms of the sample text, and preferably for all terms of the sample text. However, some words that are exceptionally common or otherwise unimportant may be skipped such that their sample frequency is not determined. For example, it may be desirable to skip determination of sample frequencies for “a”, “an”, “and”, “the”, etc. because such terms are unlikely to provide a meaningful association with, or be indicative of, a given property. Skipping such terms can save computer processing time, etc. Various techniques for skipping such terms, often referred to as “stopping”, are well known in the art.

As discussed above with reference to step 12 of FIG. 1, the sample frequencies may be determined in any suitable way, and be measured by any suitable metric, e.g. using a known indexing technique. It is often advantageous to use the same technique and metric for determining frequencies in both step 22 of FIG. 2 and step 12 of FIG. 1.

As shown at step 24 of FIG. 2, for each term (or each desired term as determined by means outside the scope of the present invention) of the sample text, the term's sample frequency may be compared to its respective reference frequency. In the present embodiment, it is considered that the terms appearing with greater frequency in the sample text than in the reference text are more important, i.e. more relevant to or more indicative of the context or gist of, the sample text. Accordingly, differences between the respective frequencies for a term may give a relative measure of that term's importance to the sample text. More specifically, a greater difference may indicate greater importance to the sample text.

The respective frequencies may be compared in various ways to determine whether a term is important, e.g. if it exceeds a threshold determined by the user or system, or how important a term is, e.g. by determining an importance score, as shown at step 26 of FIG. 2.

Alternatively, the difference may be determined as an arithmetic difference according to a desired function in which the respective sample and reference frequencies are arguments. For example, the well-known inverse document frequency (IDF) function value for a term may be raised to an exponent and used as a multiplier to the arithmetic difference between frequencies to provide a weighting when computing an importance score. Such a function is particularly useful to give rarer terms greater consideration.

As another alternative, a weighting scheme may be used. For example, when a search query is executed and the search results are used as the sample text, a weighting may be applied such that terms appearing in documents that are more relevant to the search query, e.g. as determined by a search engine, are assigned greater weight when determining an importance score. For example, when such a weighting is used, a term having a certain reference frequency but appearing five times in the ten most relevant documents of the sample text would be assigned an importance score greater than another term having the same reference frequency but appearing five times in the ten least relevant documents of the sample text, although both terms appear a total of five times in the sample text. This may be particularly advantageous when not all documents in the sample text reflect the desired property equally.

It should be noted that steps 22-26 of FIG. 2 may be repeated from time to time for various different sample texts without the need for repeated identification of reference frequencies as discussed above with reference to FIG. 1.

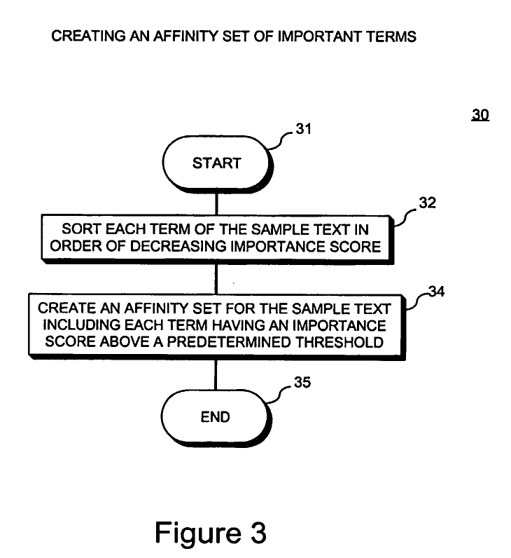

After determining every term's importance to the sample text, it may be desirable to identify and/or retain only the most important terms. A set of the most important terms is referred to herein as an “affinity set.” FIG. 3 is a flow diagram 30 illustrating an exemplary method for creating an affinity set according to the present invention. In the example of FIG. 3, creating an affinity set from the entire list of important terms involves the step of sorting each term of the sample text in order of decreasing importance, e.g. in order of decreasing importance score, as shown at step 32. By ranking terms in order of decreasing importance score, an importance-ranked list of terms is provided. The affinity set is then created to include all terms of sufficient importance, e.g. as reflected by rank or importance score. For example, the affinity set may be created to include the top X% of the terms, the top Y terms. Alternatively, for example, the affinity set may be created to include all terms having an importance score above a predetermined threshold established by the system or a user, as shown at step 34. The techniques and cutoffs may be selected according to preference. Optionally, the affinity set may be stored for future use, e.g. in a memory of a computerized information retrieval system.

The affinity set of important terms may identify terms or topics addressed by an author when the author's works are used as the sample text. By way of further example, important terms may be used to identify common phrases or speech patterns for use in drafting a future speech for the politician when transcripts of a politician's past speeches are used as the sample text.

It is noted that the important terms may be used to determine a term's sense, as described in U.S. Provisional Application No. 60/271,960, previously filed.

By way of example of the methods of FIGS. 1-3, consider that it is determined according to the steps of FIG. 1 that the terms “horatio,” “ghost,” and “fortinbras” have reference frequencies of 0.001326, 0.002320, and 0.000368, respectively, meaning that they occur in 36 documents of 27,150, 63 of 27,150 documents, and 10 of 27,150 documents, respectively, in indexed reference text including the works of Shakespeare. Consider also that a set of 89 passages containing the term “hamlet” is used as the sample text, and that the terms “horatio,” “ghost,” and “fortinbras” have respective sample frequencies of 0.067416 (6/89), 0.078652 (7/89) and 0.033708 (3/89), respectively, with respect to the sample text as determined in step 22 of FIG. 2. In step 24 of FIG. 2, the respective frequencies are used to determine importance scores of 0.066090, 0.076332, and 0.033340 for “horatio,” “ghost,” and “fortinbras”, respectively, by finding the difference between the respective sample and reference frequencies by subtraction. Therefore, “horatio” and “ghost” are deemed to be more important to the sample text than “fortinbras”. If the threshold for inclusion in the affinity set is an importance score of 0.050, “horatio” and “ghost” would be included in the affinity set while “fortinbras” would be excluded according to the steps of FIG. 3.

The affinity set is useful for various reasons, including for creating an abstract of a document in the form of a list of words that likely convey the gist of a document. For example, the affinity set for a document may be displayed on a computer display screen of a computerized information retrieval system so a user may view the affinity set list of terms as a type of abstract of the document.

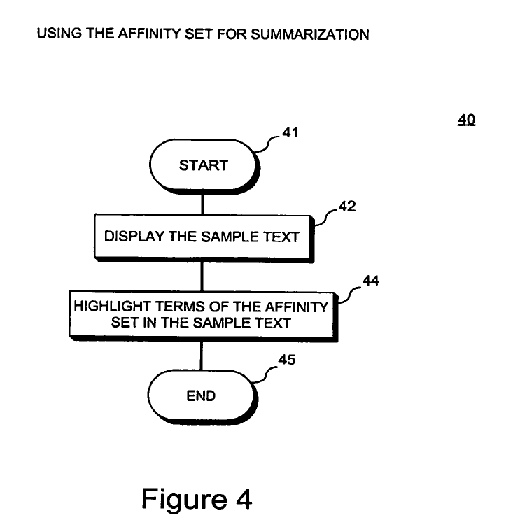

An affinity set may be used for this summarization. For example, a single document may be used to generate an affinity set and the affinity set terms may be used. Alternatively, a search query may be used to identify documents, and an affinity set for the search query may be used. FIG. 4 is a flow diagram 40 illustrating an exemplary method for using the affinity set for summarization according to the present invention. As shown in FIG. 4, the sample text, e.g. a document, may be displayed on a computer display screen to show as highlighted, e.g. bolded, the terms of the affinity set, as shown at steps 41-45 of FIG. 4. Such highlighting can allow a reader to quickly scan the document for its gist.

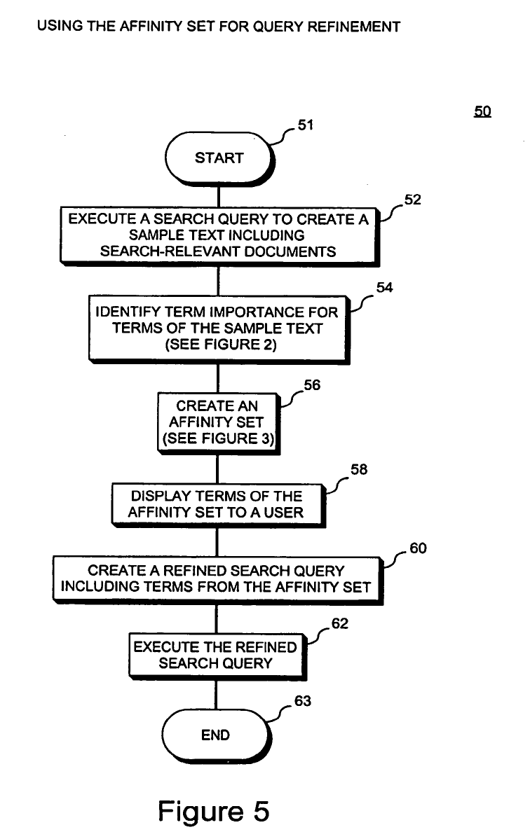

When a search term or query is used to define the sample text, the affinity set is also important to the search term or query. Accordingly, the affinity set may be used to provide terms to be used for refining or creating a search query given a search term or query. FIG. 5 is a flow diagram 50 illustrating an exemplary method for using the affinity set for query refinement according to the present invention. As shown in FIG. 5, a search query is first executed to identify sample text including search-relevant documents.

The search query could be a single or multiple-term query. For example, the search query may be provided by a user as input to an information retrieval system. Various techniques, hardware and software are well known in the art for executing a search query to identify search-relevant documents.

Term importance for terms of the sample text is next identified, as shown at step 54 of FIG. 5. This step may be carried out according to the steps of FIG. 2. Because the documents of the sample text are related to the search query, the important terms of the sample text are deemed to be related to the search query.

Optionally, an affinity set is created to include the sufficiently important terms, as shown at step 56 of FIG. 5. This step may be carried out according to the steps of FIG. 3.

The important terms, e.g. from the affinity set, may then be used to refine the search query. In the example of FIG. 5, terms of the affinity set are displayed to a user of the information retrieval system, e.g. via a computer display screen to allow a user to select important terms, as shown at step 58. This step is optional, however, as discussed below.

A refined search query is then created to include terms from the affinity set, as shown at step 60. In this manner, relevance feedback is provided. In the example of FIG. 5, the user is permitted to select terms from the affinity set (displayed at step 58) that may be added to, or used instead of, the original search query. For example, the user's selection may be provided as input to the information retrieval system as known in the art, e.g. via a keyboard, mouse, touch screen, etc.

Alternatively, the information retrieval system may select terms from the affinity set to add to, or be used instead of, the original search query. In this manner, blind relevance feedback is provided. In such an embodiment it may be unnecessary to display the entire affinity set to the user. For example, the system or the user may select a term as a function of the importance score, e.g. to use the terms having the Z highest importance scores.

In the example of FIG. 5, the refined search query is then executed to identify search-relevant documents, as shown at step 62. This allows the user and/or system to identify more relevant documents, or to broaden, narrow, or otherwise focus the search.

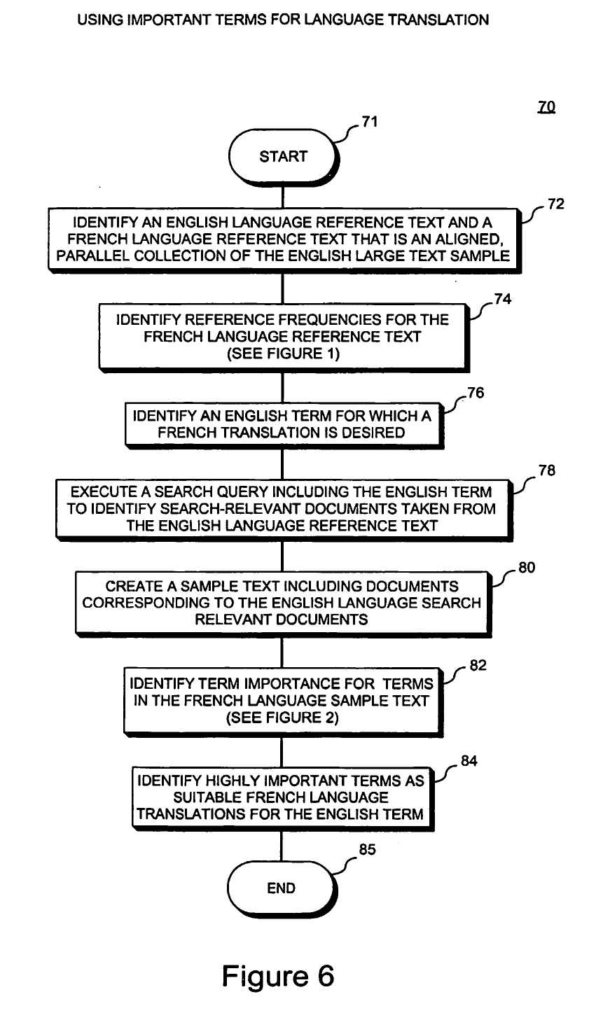

The affinity set may also be used to assist in cross-language translation of text. FIG. 6 is a flow diagram 70 illustrating an exemplary method for using important terms for cross-language translation according to the present invention. As shown at steps 71 and 72, the exemplary method starts with identification of an English language reference text and a French language reference text that is an aligned, parallel collection of the English language reference text, meaning that it has a one-to-one correspondence between English and French language documents, where each French document is a translation of its corresponding English document. For example, the Hansards of the Canadian legislature are published in both French and English and may be used as aligned, parallel collections of text.

This example considers that English is the primary language and translations in French are desired. Accordingly, reference frequencies are determined for the terms of the French reference text, as shown at step 74. For example, this step may be carried out as discussed above with reference to FIG. 1.

Next, an English term is identified for which a French translation is desired, as shown at step 76. For example, this term may be identified by a user or a computerized system for performing such a translation in an automated fashion.

A search query including the English terms is then executed to identify search-relevant documents taken from the English language reference text, as shown at step 78. This step is similar to step 52 discussed above with reference to FIG. 5.

French language documents corresponding to the search-relevant English language documents are then identified, as shown at step 80. These French language documents are considered the sample text. This step involves maintenance of a data structure or another technique to identify corresponding documents. Suitable techniques for doing so are well known in the art.

Importance of the French terms in the French language sample text are then identified, e.g. according to the method discussed above with reference to FIG. 2, as shown at step 82.

In this example, the highly important terms, e.g. affinity set terms or those with the highest importance scores, are identified as suitable French language translations of the English term, as shown at step 84. For example, these terms may be displayed by the user, incorporated into a translation of a document containing the English term, etc. The method then ends.

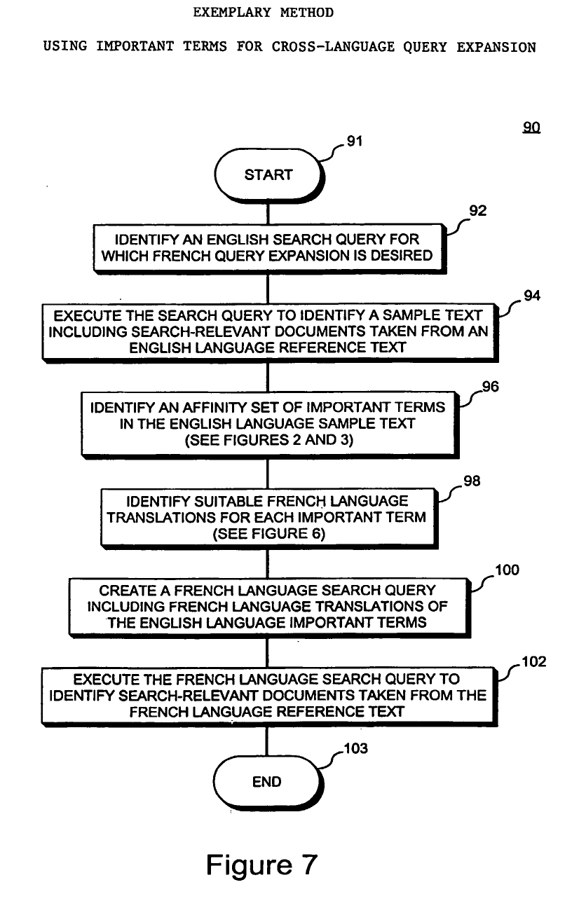

FIG. 7 is a flow diagram 90 illustrating an exemplary method for using important terms for cross-language query expansion according to the present invention. In the example of FIG. 7, English is considered the primary language and query expansion in French is desired. As shown in FIG. 7, the method starts with identification of an English language search query for which French language query expansion is desired, as shown at steps 91 and 92. For example, the query may be provided by a user as input to an information retrieval system.

The English language search query is then executed to search an English language reference text to identify search relevant documents, as shown at step 94. Methods for doing so are well-known in the art. The search-relevant documents are considered the sample text.

Important English language terms in the sample text are then identified, as shown at step 96. For example, this step may be carried out as discussed above with reference to FIG. 2.

Suitable French language translations for the English language important terms are then identified, as shown at step 98. It should be noted that the translations may be provided for individual terms of an entire list of terms. For example, this step may be carried out as discussed above with reference to FIG. 6, and may be repeated as necessary.

A French language search query is then created to include French language translations of the English language important terms, as shown at step 100. For example, this may be performed by the user, who may select the terms and provide them as input to the information retrieval system. Alternatively, this may be performed in an automated fashion by the information retrieval system, e.g. by taking the French language term having the highest importance score as the French language translation of each English language important term, and by creating the French language search query by simply substituting the English words of the search query with each of their French language translations.

Finally, in the example, of FIG. 7, the French language search query is executed to identify French language search-relevant documents taken from the French language reference text, as shown at steps 102 and 103. Alternatively, a French language collection of documents may be searched instead of the reference text. In this manner, the important terms are used for cross-language query generation and/or expansion.

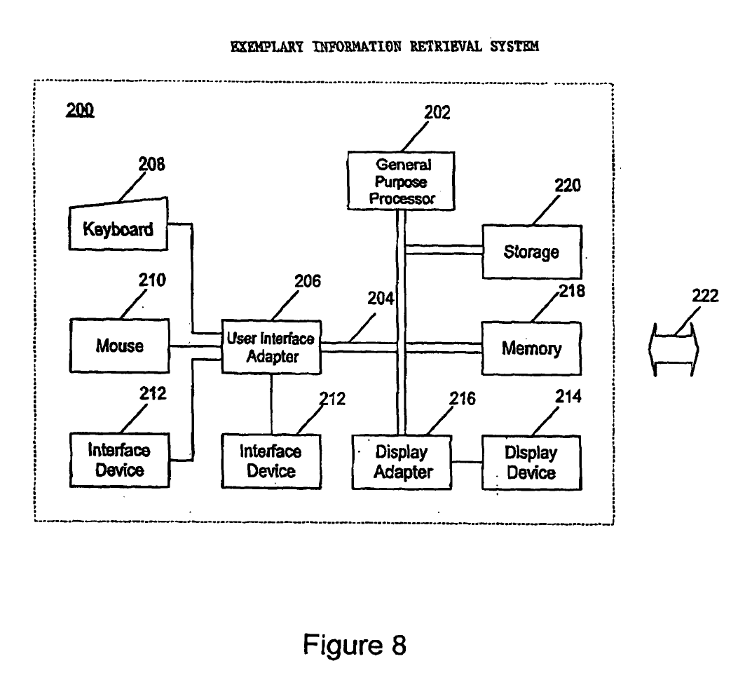

FIG. 8 is a block diagram of an information processing system 200 for identifying terms of importance to sample text in accordance with the present invention. As is well known in the art, the information processing system of FIG. 8 includes a general purpose microprocessor (CPU) 202 and a bus 204 employed to connect and enable communication between the microprocessor 202 and the components of the information processing system 200 in accordance with known techniques. The information processing system 200 typically includes a user interface adapter 206, which connects the microprocessor 202 via the bus 204 to one or more interface devices, such as a keyboard 208, mouse 210, and/or other interface devices 212, which can be any user interface device, such as a touch sensitive screen, digitized entry pad, etc. The bus 204 may also connect a display device 214, such as an LCD screen or monitor, to the microprocessor 202 via a display adapter 216. The bus 204 may also connect the microprocessor 202 to memory 218 and long-term storage 220 (collectively, “memory”) which can include a hard drive, diskette drive, tape drive, etc.

The information processing system 200 may communicate with other computers or networks of computers, for example via a communications channel, network card or modem 222. The information processing system 200 may be associated with such other computers in a local area network (LAN) or a wide area network (WAN), or the information processing system 200 can be a client or server in a client/server arrangement with another computer, etc. All of these configurations, as well as the appropriate communications hardware and software, are known in the art.

Software programming code for carrying out the inventive method is typically stored in memory. Accordingly, the information processing system 200 stores in its memory microprocessor executable instructions. These instructions include instructions for identifying a reference frequency for each of a plurality of terms.

In one embodiment, the reference frequency is identified by referencing an index stored in the memory 218. The index includes data indicating a reference frequency for each of multiple terms, e.g. terms of a reference text. The reference text may be stored in the memory. For example, the index may be prepared by the system or by an external system or external party. Optionally, the reference frequency is identified by determining a reference frequency for each of said plurality of terms. In other words, the system 200 makes the determination, e.g. by indexing the reference text.

The data information processing system 200 also stores in its memory microprocessor executable instructions for identifying a sample frequency for each of multiple terms of a sample text. The sample text may be identified as discussed above, and the sample frequency indicates a frequency of occurrence within the sample text, as discussed above.

The data information processing system 200 may also store in its memory microprocessor executable instructions for comparing a respective sample frequency to a respective reference frequency for each of the multiple terms of the sample text. In an embodiment in which an index is referenced, these instructions may include instructions for referencing the index as part of the comparing step. In this manner, importance of each of the multiple terms of the sample text may be measured as a function of said respective frequencies, e.g. by the difference, i.e. a metric reflecting the difference between respective frequencies.

Optionally, the data information processing system 200 may also store in its memory microprocessor executable instructions for assigning an importance score as a function of a difference between the respective frequencies. As discussed above, the important score may be calculated by simple subtraction of a term's sample and reference frequencies, or by any suitable function that provides a measure reflecting the relative importance to the sample text and reference text. Further microprocessor executable instructions may be stored in the memory for sorting multiple terms of the sample text in order of decreasing importance score and/or for creating an affinity set including selected ones of the terms, e.g. those having an importance score exceeding a threshold, as discussed above.

Additional microprocessor executable instructions may be stored in the memory for executing a query including a search term to identify the sample text, and for creating a refined query comprising a term from an affinity set, as discussed above with reference to FIG. 5.

Furthermore, additional microprocessor executable instructions may be stored in the memory for providing a list of documents ranked in order of decreasing relevance to a search query, and for assigning a relevance score to multiple terms of the sample text as a function of a difference between respective frequencies and the relevance ranked order of documents retrieved by executing said search query. In this manner, a weighting is applied in assigning a relevance score to reflect as more important those terms appearing in documents of greater relevance to a search result, as discussed above with reference to FIG. 2.

Having thus described particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

What is claimed is:

1. A method for identifying important terms of sample text, the method comprising the steps of:
(a) determining a reference frequency for each of a plurality of terms of a reference text, said reference frequency comprising a frequency of occurrence within the reference text;
(b) determining a sample frequency for each of a plurality of terms of the sample text, said sample frequency comprising a frequency of occurrence within the sample text; and
(c) for each of said plurality of terms of the sample text, comparing a respective sample frequency to a respective reference frequency to determine importance as a function of said respective frequencies.

2. The method of claim 1, wherein step (a) comprises an index for indexing the reference text.

3. The method of claim 2, wherein step (a) comprises referencing the index comprising data indicating a reference frequency for each of said plurality of terms.

4. The method of claim 1, wherein step (c) comprises determining importance as a function of said respective frequencies by calculating a difference between said respective sample frequency and said respective reference frequency.

5. The method of claim 4, further comprising the steps of:
(d) assigning an importance score to each of said plurality of terms of the sample text, said importance score being determined as a function of said difference; and
(e) sorting said plurality of terms of the sample text in order of decreasing importance score.

6. The method of claim 5, further comprising the step of:
(f) defining an affinity set comprising each of said plurality of terms having a respective importance score exceeding a threshold.
(g) storing said affinity set.
(h) displaying said affinity set as an abstract of said document.

7. The method of claim 1, further comprising the step of:
(d) displaying the sample text to show as highlighted any of said plurality of terms.

8. The method of claim 6, further comprising the steps of:
(f) executing a search query to identify the sample text; and
(g) creating a refined search query comprising a term from said affinity set.

9. The method of claim 8, wherein said term is selected as a function of the importance score.

10. The method of claim 9, further comprising the steps of:
(h) displaying said affinity set to a user;
(i) receiving said user's selection of said term.

11. The method of claim 8, further comprising the step of:
(h) executing said refined search query to identify relevant search results.

12. The method of claim 5, further comprising the steps of:
(f) executing a search query to identify the sample text, the sample text comprising a plurality of documents ranked in order of decreasing relevance to said search query; and
(g) assigning an importance score to each of said plurality of terms of the sample text, said importance score being determined as a function of a relevance ranked order of documents retrieved by executing said search query and a difference between said respective sample and reference frequencies.

13. An information processing system for identifying terms of importance to sample text, the system comprising:
a central processing unit (CPU) for executing programs;
a memory operatively connected to said CPU;
a first program stored in said memory and executable by said CPU for identifying a reference frequency for each of a plurality of terms of a reference text, said reference frequency comprising a frequency of occurrence within the reference text;
a second program stored in said memory and executable by said CPU for identifying a sample frequency for each of a plurality of terms of a sample text, said sample frequency comprising a frequency of occurrence within the sample text; and
a third program stored in the memory and executable by the CPU for comparing a respective sample frequency to a respective reference frequency for each of said plurality of terms of the sample text, whereby importance of each of said plurality of terms of the sample text is measured as a function of said respective frequencies.

14. The system of claim 13, wherein said first program is configured to identify said reference frequency by referencing an index comprising data indicating a reference frequency for each of said plurality of terms.

15. The system of claim 13, wherein said first program is configured to identify said reference frequency by determining a reference frequency for each of said plurality of terms.

16. The system of claim 15, wherein said first program is configured to determine said reference frequency by indexing the reference text.

17. An information processing system for identifying terms of importance to sample text, the system comprising:
a central processing unit (CPU) for executing programs;
a memory operatively connected to said CPU;
an index stored in said memory, said index comprising data indicating a reference frequency for each of a plurality of terms of a reference text, said reference frequency comprising a frequency of occurrence within the reference text;
a first program stored in said memory and executable by said CPU for determining a sample frequency for each of a plurality of terms of the sample text, said sample frequency comprising a frequency of occurrence within the sample text; and
a second program stored in said memory and executable by said CPU for referencing said index and comparing a respective sample frequency to a respective reference frequency for each of said plurality of terms within said sample text, whereby importance of said plurality of terms of said sample text is measured as a function of said is respective frequencies.

18. The system of claim 17, further comprising:
a reference text stored in said memory.

19. The system of claim 17, further comprising:
a third program stored in said memory and executable by said CPU for assigning an importance score as a function of a difference between said respective frequencies; and
a fourth program stored in said memory and executable by said CPU for sorting said plurality of terms of said sample text in order of decreasing importance score.

20. The system of claim 19, further comprising:
a fifth program stored in said memory and executable by said CPU for defining an affinity set comprising each of said plurality of terms having a respective importance score exceeding a threshold.

21. The system of claim 20, further comprising:
a sixth program stored in the memory and executable by the CPU for executing a query including a search term to identify the sample text; and
a seventh program stored in the memory and executable by the CPU for creating a refined query comprising a term from said affinity set.

22. The system of claim 17, further comprising:
a third program stored in the memory and executable by the CPU for executing a search query to identify the sample text, the sample text comprising a plurality of documents ranked in order of decreasing relevance to said search query; and
a fourth program stored in the memory and executable by the CPU for assigning a relevance score to said plurality of terms of said sample text as a function of a difference between said respective frequencies and relevance ranked order of documents retrieved by executing said search query.

23. The method of claim 8, wherein said term is selected from said affinity set to provide a scope of said refined search query that is greater than a respective scope of said search query.

24. The method of claim 8, wherein said term is selected from said affinity set to provide a scope of said refined search query that is less than a respective scope of said search query.

25. The method of claim 6, further comprising the steps of:
(g) executing a search query to identify the sample text; and
(h) creating a refined search query excluding a term of said search query that is not included in said affinity set.
